(19) United States
(12) Patent Application Publication
(10) Pub. No.: US 2010/0084412 A1
(43) Pub. Date: Apr. 8, 2010

(54) ENERGY EFFICIENT RANGE

(76) Inventor: Lee Lisheng Huang, Palo Alto, CA (US)

Correspondence Address: PERKINS COIE LLP, P.O. BOX 1208, SEATTLE, WA, 98111-1208, US

(21) Appl. No.: 12/246,457

(22) Filed: Oct. 6, 2008

(51) Int. Cl. A47J 27/00; A47J 36/00

(52) U.S. Cl. 220/608; 220/573.1; 126/373.1; 126/390.1; 29/890.03

(57) ABSTRACT

Techniques for designing and creating energy efficient cookware are provided. In accordance with the techniques cookware can include a base and a wall and a linear pattern of flame guide channels connected to the base bottom. The guide channels accept flames and guide them to the perimeter from the central region resulting in efficient heat exchange. The linear channel profiles provides significant surface area enhancement from a given area on the bottom to improve heat transfer while providing even heating and mechanical strength to the cookware. A flame entrance opening is provided in the center region of the base to allow easy entrance of the flame into the channels. A gas burner flame pattern is provided to work with the linear channels profiles of the cookware to further improve the energy efficiency. A method of making the efficient cookware is provided involving deep drawing an extruded fin plate; A method of making the efficient cookware is provided involving spin cutting and spin forming of an extruded plate. A plate with heat exchange features that can be used either as the base of a piece of cookware or attached to the base of a piece of cookware can improve efficiency of heat transfer to the cookware.

### FIELD OF THE INVENTION

The invention relates generally to cookware. More particularly, the invention relates to heat transfer from a heating element to cookware, especially from a flame over a gas range during a cooking process.

### BACKGROUND

Cookware is a basic tool used daily in human life. Regardless of different shapes of cookware, ranging from a stock pot to a wok, to a frying pan, cookware can include two basic elements: one for receiving heat from a heat source, and one for heating food. Heat energy can be generated from a variety of sources, for example electricity, or a burning flame. The heat energy is transferred from the source to the heat-receiving surface of the cookware, conducted through the cookware and transferred to food in the cookware.

Heat transfer from combustion sources can be inefficient. The utilization of thermal energy from gas on a typical gas range for heating up cookware is reported to be only about 30%. This means a lot of energy is wasted during the cooking process. As a result, people pay unnecessarily high energy bills and produce unnecessary, undesirable CO₂ into the environment.

For gas ranges, effort has been directed to optimize burners so that there is a good mix of air and fuel in order to completely combust the fuel. Attention has also been paid to distribute the heat evenly across the base of a piece of cookware. However with respect to combustion cooking, there has been limited effort made to improve the energy receiving end of the process.

### SUMMARY OF THE INVENTION

A piece of cookware typically has a base and a wall, where the wall extends from the top side of the base and spans a perimeter of the base. In U.S. patent application Ser. No. 11/992,972 the present inventor suggests a new type of cookware that has at least one pattern of flame guide channels connected to base of the cookware, and a flame guide channel made from a pair of guide fins. The guide fins have a flame entrance end near a center region of the base, and have a flame exit end positioned towards the perimeter of the base. At least one pattern of perturbation channels is included, where a perturbation channel is made from a pair of perturbation fins. The perturbation fins can have a first perturbation end positioned away from the central region and a second perturbation end positioned towards the cookware perimeter. The flame guide channel accepts a flame from a stove burner and guides it towards the perimeter from the central region. The perturbation fins generate lateral turbulence in the guided flame by interfering with an onset of laminar flow in the flame as the flame moves along the guide channel. The induced turbulence increases heat transfer from the flame to the base and fins, while minimizing mixing of the flame with ambient air. Such induced turbulence promotes conduction of the flame heat through the cookware and to food for more efficient cooking.

In addition to the perturbation feature in the channels in U.S. patent application Ser. No. 11/992,972, a pattern of linear guiding channels is discussed herein. The pattern of linear guiding channels can maximize a channel exchange surface enhancement for a given original plain surface area.

As discussed herein cookware can include a channel width profile across the base of the cookware to allow a hot flame to easily enter into channels for efficient heat exchange. To further facilitate the flame to entrance the channel, the tips of the fins forming the channel are rounded to reduce flow entrance impedance. The thickness of the fins is tapered so that the width of the fins is thinner at the top and thicker at the base to allow easy entrance of the flame.

Cookware can provide a flame entrance opening in channel pattern to facilitate flame flow into linear channels.

Additionally, heat exchange channels can be used in pressurized cookware, for example, a pressure cooker. Such a pressure cooker can make use of the combination to produces a very efficient piece of cookware for a gas range.

Further, a manufacturing process is disclosed that can produce the cookware with a high density of heat exchange channels cost effectively while using materials with a good thermal conductivity. Such cookware can also be manufactured in stainless steel in accordance with a manufacturing process to produce stainless steel cookware with linear heat exchange channels on the bottom.

Also disclosed is a metal plate that has heat exchange features that can be implemented as the base of a piece of cookware or attached to the base of a piece of cookware to improve the efficiency of the piece of cookware.

A gas burner is disclosed for a range top, that can be used with the cookware described above to further enhance the cooking efficiency. The gas burner can generate a suitable flame pattern to be used with cookware having linear heat exchange channels, especially suitable with those with flame entrance openings.

### BRIEF DESCRIPTION OF THE FIGURES

Objectives and advantages disclosed herein will be understood by reading the following detailed description in conjunction with the drawing, in which:

FIG. 1 shows a radial pattern of heat exchange channels

FIG. 2 shows a unit of cookware with a linear pattern of heat exchange channels

FIG. 3 shows a piece of cookware having a square base with a linear pattern of channels

FIG. 4.1 shows guide fins with flat tops

FIG. 4.2 shows guide fins with rounded tops

FIG. 5 shows a channel profile which width varies across the base

FIG. 6 shows a unit of cookware with a circular flame entrance opening in the center region

FIG. 7 shows cookware with a rectangular flame entrance opening in the center region

FIG. 8 shows a burner that generates a rectangular flame profile

FIG. 9 shows preferred flame patterns

FIG. 10.1 shows an extruded plate with channel fins.

FIG. 10.2 shows an extruded plate with channel fins removed from the edge area

FIG. 10.3 shows a unit of cookware formed after the extruded plate is stamped.

FIG. 11 shows the setup for attaching extruded heat channel plate to the bottom of a piece of stainless steel cookware.

FIG. 12 shows a unit of cast cookware with channel fins.

### DETAILED DESCRIPTION

Although the following detailed description contains many specifics for the purpose of illustration, anyone of ordinary skill in the art will readily appreciate that many variations and alterations to the following exemplary details may be made.

In a typical process, a piece of cookware holding a medium such as water is placed on top of a flame from a burner. The flame rises up due to pressure of the gas in the supply piping and the buoyancy of the hot air causes the flame to touch the base of the cookware. Heat is transferred from the flame to the base via convection transfer as well as radiation transfer. The heat is absorbed from the heat-receiving surface and is transferred to the food surface by thermal conduction. Heat is then transferred from the food surface to the water via conduction and convection. In this whole process, the heat transfer from the flame to the cookware body via convection transfer is the most inefficient step limited by the thick boundary layer of the flame flow, while the heat transfer from the cookware to the content is the next inefficient also limited by boundary layer of the liquid content. The heat conduction inside the body of the piece of cookware is efficient where the cookware is constructed of metal.

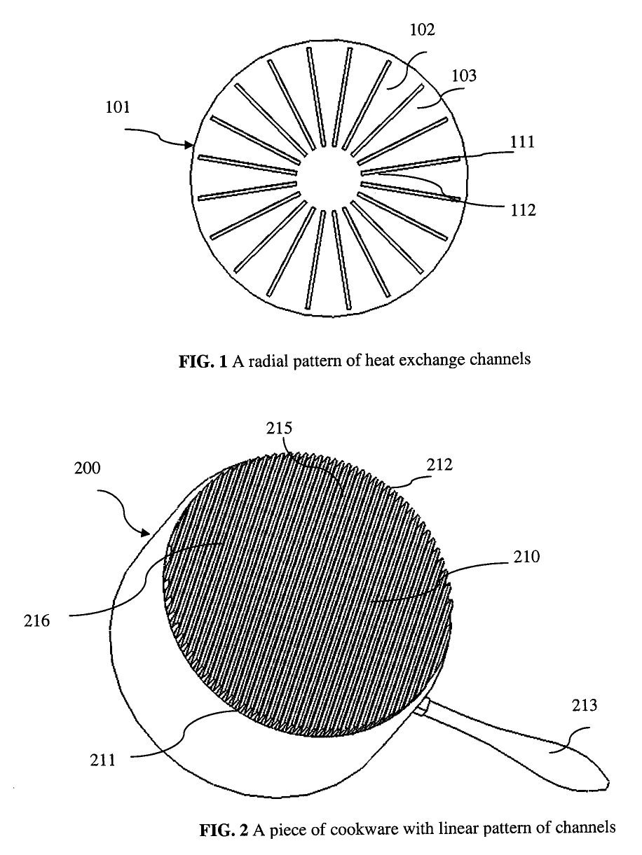

Heat exchange channels are proposed to improve the heat transfer efficiency. A radial heat exchange channel pattern described in U.S. patent application Ser. No. 11/992,972 is shown in FIG. 1. This is the bottom view of the piece of cookware 101. There is a pattern of channels formed by fins protruding upward from the base of the piece of cookware 101. As used herein, a “channel” is defined as the space in between a pair of fins and the base along the direction of the fins. For example, fins 102 and 103 form a channel in the space between them. The ratio between the height of the fins and the distance between the fins is larger than one so as to have a recognizable channel guiding the heat exchange effect. In the radial pattern in FIG. 1, the channel width will change along the path. As indicated in FIG. 1, the width of the channel at location 111 is larger than that in location 112 which is closer to the center of the radial pattern. However, for any given manufacturing method, there is a limit on the smallest dimensions, such as for gaps and fin width. This limit can determine whether or not the surface area enhancement for the exchange channels over a flat surface can be achieved. It will be preferable to keep the channel width at a minimum dimension allowed by the manufacturing process. Therefore a radial pattern with varying widths makes it difficult to utilize the maximum surface area improvement that a given manufacturing process can provide.

In a linear patterned heat sink structure, on the other hand, the channel spacing can be constant. Therefore it is possible to construct or define channels across the whole base of the piece of cookware using the smallest dimension a given manufacturing process can produce. This linear pattern can create the more surface area improvement in a channel format over the original flat surface for a given size of the flat surface area as compared with the radial pattern.

A piece of cookware with linear pattern heat exchange channels is shown in FIG. 2, in this case, a pot. The piece of cookware 200 includes a linear pattern of channels 210. The channel width is constant along the length of the channels. A typical flame from a burner will be placed close to the center region of the cookware. Once the flame enters the channel, the flame will be guided to flow towards the perimeter of the base of the piece of cookware. Eventually the flame exits the channel at the perimeter indicated by 211 and 212. As the flame flows along the channels, heat is transferred from the flame to the base and the fins. The material of the fins can have a high thermal conductivity coefficient, therefore heat absorbed by the fin can be conducted to the base easily to help the overall heat transfer from the flame to the food inside the cookware. This can be viewed as an increase of heat exchange surface area effectively for the energy to transfer from hot flame to the body of the cookware. Also seen in FIG. 2, a handle 213 extends from the wall at locations away from the output of channels, in this example perpendicular to the output. Advantageously, the handle will not be heated by flames escaping from the channels. This improvement can reduce the risk of a burned hand.

Advantageously, there is a substantial improvement over conventional cookware when using a linear channel pattern with a plain surface. For example, consider a piece of aluminum cookware having an 8 inch diameter with guide fins having a width of 0.08 inches, and a gap of 0.15 inches and a height of 0.5 inches. This exemplary piece reduced cooking time by about 50% as compared with a similarly sized conventional piece of cookware without the exchange channels, as they were tested on a GE Monogram gas range. The decrease in cooking time of the improved cookware significantly improves energy utilization in cooking over a gas range.

Another example follows. It is found in experiments that the use of cookware having an 8 inch square base with heat transfer channels over an 8 inch square base piece of cookware without heat transfer channels is about 10% larger than the improvement from an 8 inch round base cookware with the same heat transfer channels over a round base cookware without the heat transfer channels. The channel design in both cases is the same: width of the channel is 0.15 inch, the fin width is 0.08 inch and the height is 0.5 inch. This result indicates that the extra channel length at the corner of the square base cookware confines the flame for heat exchange while in the round base cookware the channels at the perimeter of the base run off quickly. Since the heat exchange happens inside the exchange channel, the extra channel length at the corners is what makes the difference. This effect can be significant on a range which has a high fuel speed where the complete combustion of the fuel may happen at a distance from the exit of the burner. To make a square based piece of cookware with a normal round cookware look, a design of the square base cookware can have a round top opening.

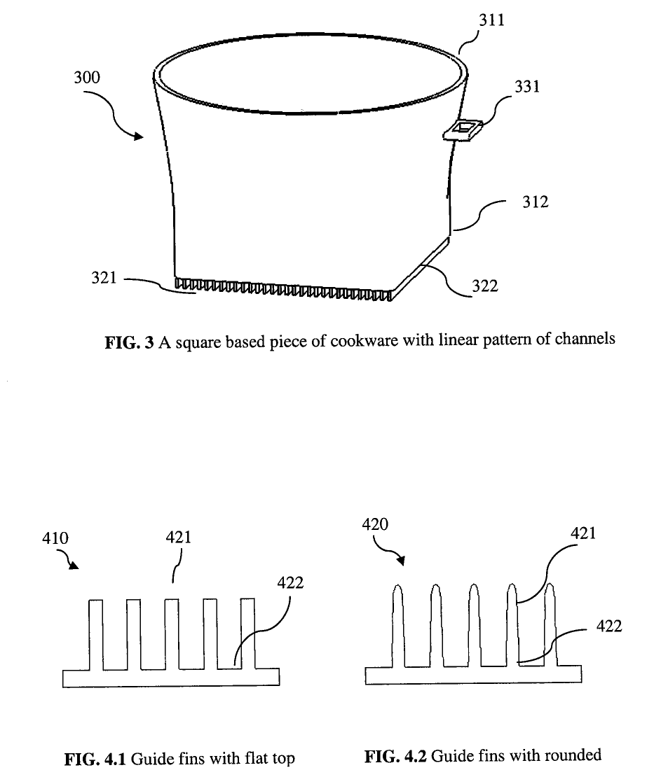

FIG. 3 depicts an exemplary piece of cookware 300. The piece of cookware 300 has a wall that is circular at the top 311, but squared at the bottom 312. This can be done by using a standard progressive deep draw manufacturing process. The exchange channels 321 are built to be in parallel to one of the edge 322 of the square base. This use of parallel channels will give extra channel space in the corners of the base to transfer thermal energy. A handle 331 is attached on the wall in area above the edge 322 which the heat exchange channels are made parallel to. Since hot flame is guided to flow along the direction of the edge 322, the handle 331 will be less likely to be heated by the flame.

To have efficient heat exchange in the channels, hot flame must be allowed to flow into channels freely without too much impedance. It is found in that this requirement need to be balanced with the need of enhancement of surface area. To have a large surface area enhancement, it can be desirable to have dense fins which lead to thinner fins and therefore narrower channel widths. However if the width of the channel is too narrow, the density can limit the ability of hot flames to enter into the channels. The ratio between the thickness of the fin at the entrance ω_{f}, and the width of the channels ω_{c} is defined as the impedance Ωₑ to the flame entrance to the channels, Ωₑ=ω_{f}/ω_{c}. To reduce the flame entrance impedance, the thickness of the fin should be small. However, when the fin is too thin the fin will be more easily damaged during daily use even the heat transfer efficiency from the height of the fins to the base can be comprised. So it will be preferable to reduce the impedance while retaining the strength of the fins. One way to reduce the impedance is to sharpen the top of the fins by rounding and tapering. FIG. 4.1 shows a fin structure 410 where the fin width is denoted as 411 and the channel width is 412. A typical fin top is flat; the impedance of the air can be represented by the ratio of fin width 411 over channel width 412. As shown in the FIG. 4.2 the top of the fins in fin structure 420 are rounded up. The top of the fins is smaller making the effective width of the fin smaller therefore reducing the impedance to hot flame when it enters to the channels. Also see in the figure, the thickness of the fin at the top end 421 is smaller than the thickness of the fins 422 at the base. This rounded tapered fin reduces the flame entrance impedance therefore improving the heat transfer efficiency.

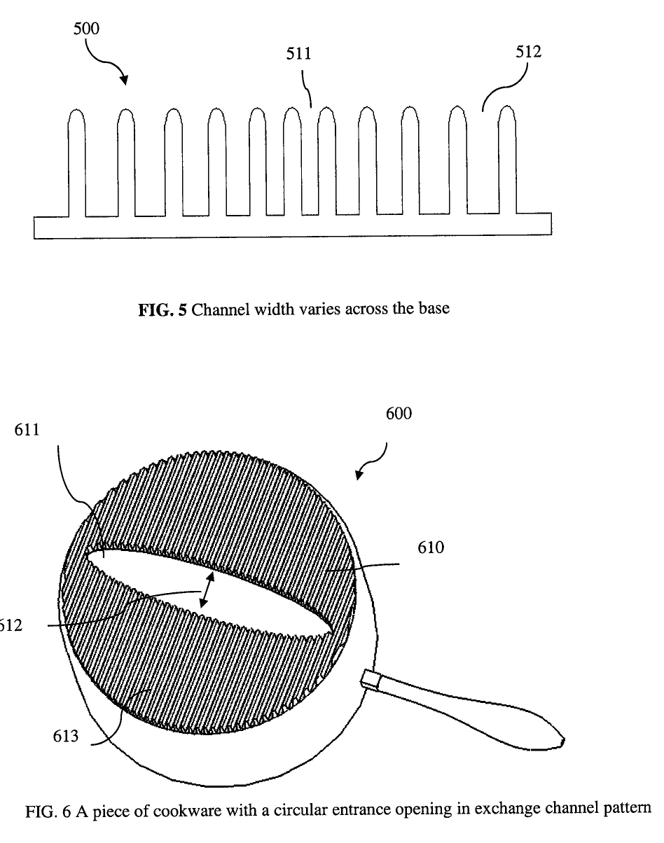

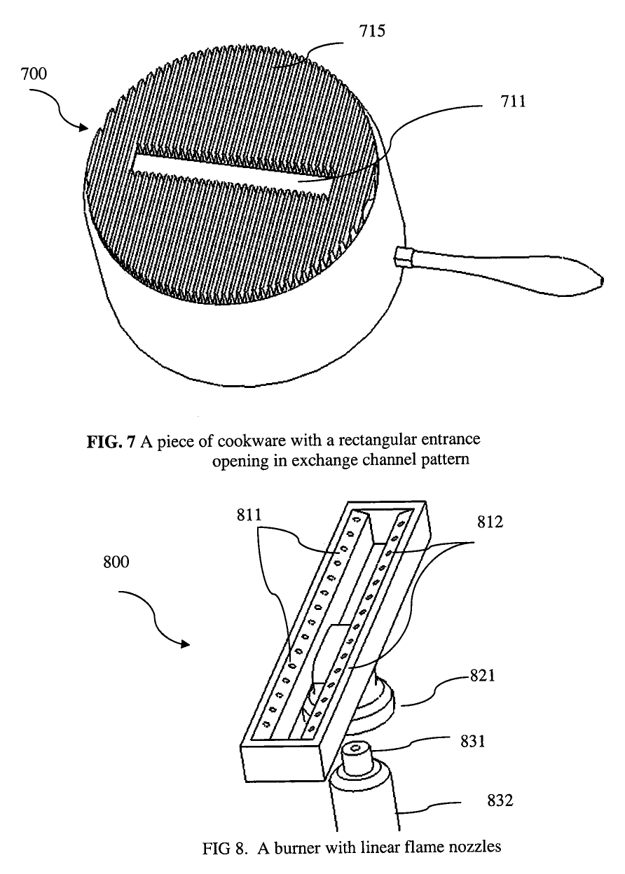

Besides the impedance, the entrance of a flame to channels is also affected by the direction of the flame flow with respect to the direction of the channels. A typical burner generates a symmetric central flame flow. As the flame flows upward due to buoyancy into the channels, it also flows outward in a radial direction. For the piece of cookware shown in FIG. 2, as the flame goes outwards, the outward flow velocity in region 215 is in general the direction of the channels. The flow can enter into channels easily, and therefore the channel density can be made higher. On the other hand, in region of 216, the flow velocity has a large component in perpendicular to the direction of the channels. It is preferable to have the width of the channels to be larger in this region to allow the flow to enter the channels easier. FIG. 5 shows a channel pattern 500 where the channel width varies across the base. The channels in region 501 are in the same general direction of the flame flow, the channels width can be narrower to have denser fins therefore bigger surface area improvement. While in the region 502, the flame's radial flow has a large velocity component running perpendicular to the direction of the channels. Therefore it is preferable to have wider channels in this region to allow easier entrance of the flame flow into the channels. Different range burners from different vendors will have different flame flow profiles and temperature distributions. Therefore the variation in channel width should be optimized accordingly for different ranges.

The flame flow entrance impedance to the channels plays an important role in the efficiency of cookware. In an experiment, a piece of cookware with guide fins width of 0.08 inch, gap of 0.1 inch and height of 0.5 inch was tested. This channel fin density is higher than the one with guide fins width of 0.08 inch, gap of 0.15 inch and height of 0.5 inch described in the example in the previous example, therefore efficiency was expected to be higher from the surface area point of view. However the efficiency dropped by 10% from the design described above which results in 50%. This is because entrance impedance of the flame flow to the channel this one is 0.8 compared with 0.53 for the previous one. The higher flow entrance impedance makes the efficiency lower even the surface area is larger. By cutting 3 slots of 0.25 inch across the channels in the center region to facilitate the entrance of the flame does set the efficiency back by 5%. This illustrates the importance of reducing the flame entrance impedance. The cutting of the slots helps the flame to get in to the channel. So it is important to reduce the entrance impedance for efficient heat exchange.

Therefore a flame entrance opening can be made in the channels can help a flame enter the channels. An entrance opening is an area of the base where the height of the fins is zero or is substantially lower than the height of the other fins. For example a circular area in the center of a base can be made such that there are no fins. The size of the area can be matching the size of a flame from a burner. The flame comes out from a burner, rises up due to buoyancy force to entrance opening and bonded by the base inside the entrance opening. The hot flame has to go into the channels to continue to flow, and escapes from the perimeter of the base. Therefore via the entrance opening, flame can have complete entrance into the channels resulting improved efficiency. Typical burner flame patterns on the market are circular and donut shapes, however, it can be suitable to have the entrance opening be a circle or an elongated circle or even an ellipse.

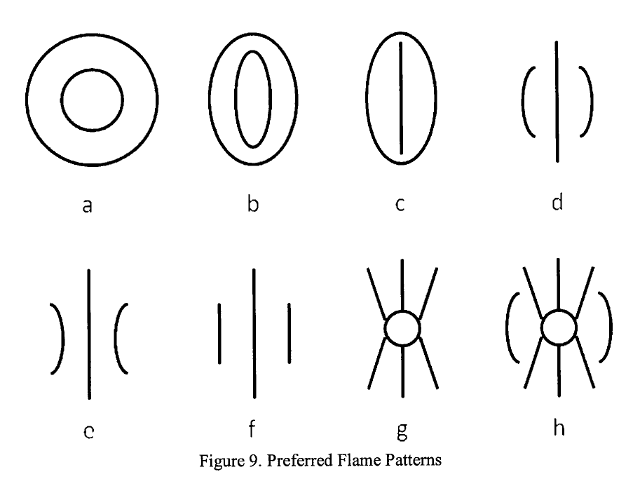

An energy efficient piece of cookware having an elliptical entrance opening in the channels is shown in FIG. 6, in this case, a pot. The piece of cookware 600 has exchange channel pattern 610, and there is an elliptical entrance opening 611 in the center region of the base of the piece of cookware 600. This elliptical opening is in general matched with the conventional range flame pattern. The short axis 612 of the elliptical shape is in the direction of the channels 610. Hot flame that gets into the entrance opening has to come out through the channels to the perimeter of the base. However, due to the opening, the length of the channels in region 613 is reduced somewhat compared to otherwise without opening.

To preserve the length of the linear channels for effective heat exchange, a rectangular entrance opening can also be used. A rectangular entrance opening can be made in the center region of the channel pattern, which will be oriented such that the length direction of the rectangle transverses the direction of the channels. This rectangular flame entrance opening in the channel fins allow the flow to enter to the channel efficiently.

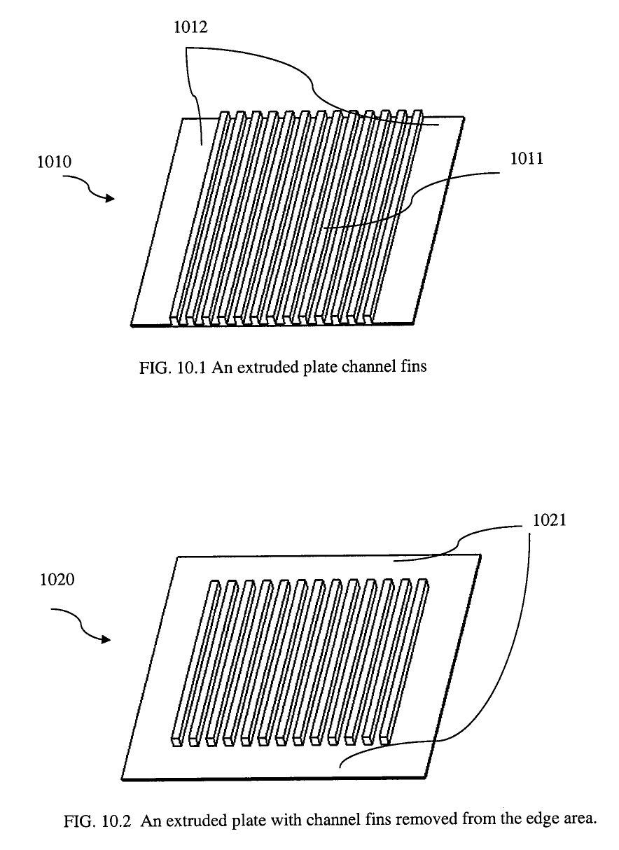

A piece of cookware having a rectangular flame entrance opening is shown in FIG. 7. The heat exchange channels pattern is linear, and there is an area 711 in the center region that does not have fins. In this area, the flame flow is directed to enter channels and then flow away from the base. This pattern is especially suitable for cookware with square base.

To effectively utilize the rectangular flame entrance to preserve the length of the channels for heat exchange, the flame source can use a rectangular pattern as a significant amount of flame flow will couple into the rectangular or squared entrance opening and therefore flows into the channels. For example such a flame pattern can be generated by a burner shown in FIG. 8. An open flame burner 900 has two rows of fuel ports 811 and 812. This forms a rectangular pattern. When a cookware shown in FIG. 7 is placed over this flame source, with the rectangular entrance opening 711 is aligned to the rectangular flame pattern of this burner, the hot flame will be able to enter the channels effectively. The length of the rows is 813, the distance between the rows is 814. To reduce the impact to the channel length, the distance 814 is small. The ratio of 814 over 813 is small, making this a line shape. In flow dynamics, when a flow with a line shape cross-section hits a flat surface, the flow tends to split up and flow in two opposite directions that are perpendicular to the direction of the line shape of the incoming flow. For example a vertically descending line shape flow with the line oriented in north-south direction could be used. When the flow hits the ground, the majority of the flow will split to flow to east and west respectively. This property makes a line flame pattern or rectangular flame suitable for the linear pattern channels when it is aligned such that the long side of the rectangle is perpendicular to the channel direction. This effect is beneficial for linear channel patterns with or without a flame entrance opening.

As shown in the figure that row 811 of fuel ports is slightly facing toward the row 812 fuel ports and vice versa. The fuel ports from two rows will be offset such that the flame will form one line at a distance, ideally this line is located inside the rectangular entrance opening of the cookware when the cookware is placed over the range during cooking.

In this example of a rectangular burner, an inlet port 821 is at the low portion of the burner. A nozzle 831 is connected to the incoming gas pipe 832. Gaseous fuel exiting from the nozzle will mix with air before arriving at the inlet port 822 of the burner. The burner can be mounted so as to be rotated about an axis that is along the center line of the inlet. This gives flexibility to align the flame pattern to a particular cookware channel pattern and entrance opening pattern.

The flame exiting from the burner is very hot, and cools down as it flows along the channels. Therefore the reduced or zero height of the fins in the flame entrance will help make the heating uniform. In fact, a height profile can be another parameter to adjust to achieve uniform heating.

Typically the cookware is put on a grate of a range top burner. Due to the extra height of the fin of the new cookware that space out the cookware base away from the burner. The grate of the burner needs to be redesigned to lower the cookware to optimize the heat transfer from the flame to the cookware.

In the same spirit, the flame pattern for a counter top range can be designed not to have center symmetry which is general the pattern available in the market. Several of such asymmetric flame patterns are shown in FIG. 9. The flames exiting from the burner are indicated along the lines indicated on the figure. The pattern a. is a typical ring pattern in most of the ranges available on the market. It includes two concentric rings of flame. One characteristic of this pattern is that there tends to be a space in the center of the pattern where that the flame stagnates and may even become stationary producing a thick boundary layer affecting heat transfer. Pattern b. is elongated version of the pattern a. The inner ring shape can match the elliptical flame entrance opening of a piece of cookware as shown in FIG. 7, in that example, a pot. In cooking food at a “simmer,” the control of the range allows only the inner ring is lit. The flame from this ring can enter the channels of a piece of cookware with linear channels, and have effective heat exchange. Pattern c. has line flame sources that can be matched well with the flame entrance opening of a piece of cookware as shown in FIG. 6, in that example, a pot. The rest of the patterns are some variations derived. Among them the patterns c, d, e, and f have a line of flame running through the center line of the base of the piece of cookware. Therefore there will not be any stationary flame flow as there would be with the circular flame pattern described above. This feature will result in better heat transfer as compared with the conventional flame patterns. These patterns have the flame port in lines in prefer direction of vertically. During use, the pot is placed such that the channels of the pot will run in the horizontal direction relative to the flame produced by the burner. If the channels pattern has a flame entrance opening, then the flame entrance opening will in line with the flame pattern. This way the flame will be linearly aligned with the heat exchange channels of the pot to better utilize the energy carried by the flame.

Currently the flame pattern of many range top burners is circular, however, some have a star pattern. It is possible to produce a burner profile adaptor that can convert the circular flame to the flame profiles shown in FIG. 9 which is suitable for cookware with heat exchange channels. For example, for cookware designed for a linear flame pattern, it is possible to make adaptor that can transform the circular flame pattern to a more elongated pattern, which has many advantages as discussed above. Alternatively, it can be possible to provide adaptor plug to plug some of the flame ports on the existing flame pattern to reduce degree of circular symmetry of the burner. This can cause the burner to produce flames in an elongated direction. Such an adaptor can help improve efficiency of the cookware with linear exchange channels as compared with use on a standard range.

A pressure cooker can utilize high pressure to help expedite the cooking of food such as meat, and bones. High pressure can help reduce the cooking time observed at otherwise normal atmospheric pressure. High pressure does not improve the speed of increase of temperature in the medium, and high pressure can delay the boiling of the water, for example where a lid is sealed on a pot when at the beginning to heat the pot. In pressure cooking, a leak tight feature can be activated by the boiling of the water. A decompression means is implemented to release the pressure once the cooking is done, for example a bleed valve and or locking device. Heat-exchange channels can be made to a pressure cooker to further improve the performance of the pressure cooker by improving the absorption of the energy from the flame into the pressure cooker. This will not only reduce time required to raise the temperature or pressure, but also reduce the amount of the fuel burned to maintain the designed cooking pressure or temperature. This combination of heat exchange feature and the pressurized cooking can be an ultimate gas cooking energy saving solution.

In order to achieve the benefits of the energy efficient cookware in a market place, it is important to be able to manufacture the heat exchange channel on cookware cost effectively and energy efficiently. One way to achieve a low cost linear channel structure is via extrusion. Aluminum extrusion is a low cost manufacturing process that routinely generates a large volume of aluminum structures in daily uses such as window frames, table frame, etc. Aluminum extrusion is capable of fabricating fine fins. On top of that, in an extrusion process, aluminum alloys with very good thermal conductivity can be used. For example Aluminum alloys, for example, 6063T5 having thermal conductivity of 209 W/mK can be used in extrusion whereas the aluminum alloys A380, which has a 110 W/mK thermal conductivity, used in majority in die cast process. Use of 6063T5 can lead to good thermal conductivity in the body of cookware which can lead to efficient heat transfer. This is because the transfer occurs from the height of the fin to the base where the thermal conductivity of the aluminum or other material limits the heat transfer. Therefore the effective area enhancement varies with the thermal conductivity of the material used, implicating the importance of thermal conductivity for thermal conduction from the flame to the food surface.

In an exemplary process for making a stockpot of 12 inch diameter, the extrusion die can be designed to be 12 inches wide. The fin width is about 0.08 inches and the channel width can vary from 0.1 inch to 0.2 inch from center to the two edges in linear fashion. The fins are denser in center region than the region on the edges. The thickness of the extrude base is 0.125 inch. The extruded plate can be extruded to up to 40 feet long. The length of the extruded plate is cut to a length for transportation, preferred to be multiple of the diameter of the cookware base plus the slot width from cutting. An exemplary material that can be used is the 6063 aluminum alloy. The extruded plate is then cut in to 12 by 12 inches square base pieces. The square base plate is then machined to a round base. More efficiently, the piece can be cut into round pieces directly by water jet or laser cutting.

The wall of a piece of cookware, such as a stock pot, can be made by using a deep draw process or a metal spinning process. The bottom of the deep drawn container can then be cut off or punched off. For small diameter cookware, the wall can also be fabricated by extrusion. Typical thickness of a wall fabricated by such a process is 0.125 inches. The base is then welded to the wall with the side of the base having the heat exchange channels facing outside. Exemplary methods of welding are laser welding, friction stir welding, fusion welding or blaze welding. For square base cookware, the wall can be especially deep drawn such that the top of the wall is formed as a circle while at the bottom it is square. The punch of the deep drawing machine can be squared and the die used circular. Care is needed to design the punch and the process of draw so as to avoid punching through the wall at the corners. To make a piece of cookware having a square base, there would not be a need to cut a circular base out of the extruded square or rectangle. This significantly reduces material scrap rate and lowers the cost of manufacture as additional benefits of using a square base.

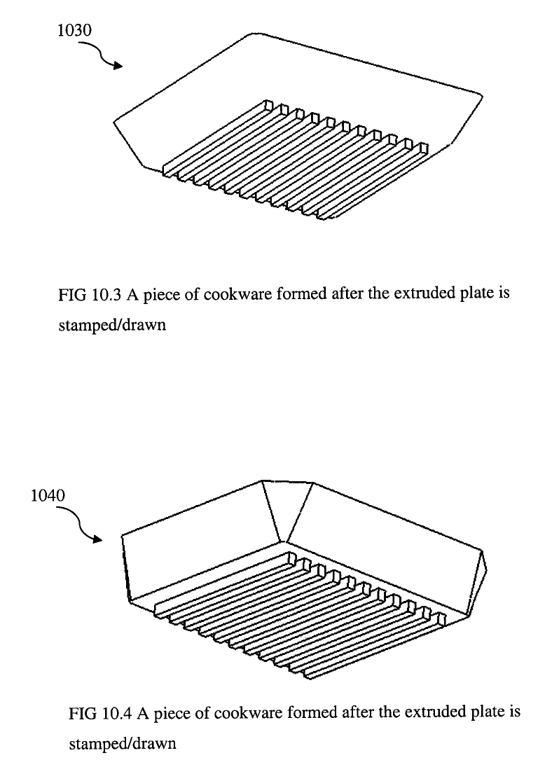

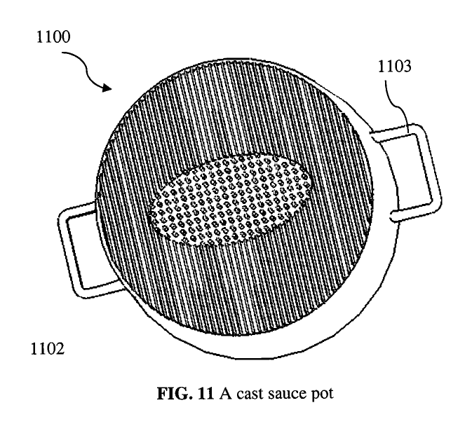

To make cookware having lower wall heights, for example, a sauté pan or a frying pan, an extruded plate can be used. The extruded plate can have a base that is larger than the channel fin area. Edge areas without the channel structure can be formed to be the wall of the cookware by, for example, deep draw or stamping. An exemplary extruded plate is shown in FIG. 10.1; an extruded plate can be made in such way that the plate has channel fins pattern 1011 running all the way in one direction while having regions 1012 on near the edge clear of fins. The plate is then machined to remove the fins in regions 1021 as shown in FIG. 10.2. Then the machined plate 1020 is put in a deep draw machine or a stamping machine to form a cavity from plain side of the extruded plate. The edges can be machined off and a body of a cooking pan 1030 can be formed as shown in FIG. 10.3.

To have extra relieves on the wall during the draw, stamping, an extra fold can be placed at the corners. As shown in FIG. 10.4, the cookware 1040 is formed by, for example, the deep draw or stamp process. The wall shape at the corner location has an extra bend to facilitate the process providing extra stress relieve.

In the deep draw process, the dimensions of the base of the extruded plate will be forced to change, the dimension of the heat exchange channels will therefore be changed. In particular, the distance between fins will increase during this process. The amount of the change will also depend on the type of cookware made, the depth to the draw, the thickness of the base and the material in use. Therefore the design of the exchange channels in the extruded plate will need to be made denser. This will allow the channel density (i.e. the fin gap) to have the targeted dimensions in the final product.

Alternatively, the guide fin channel pattern in FIG. 10.2 on the extruded plate can also be machined to be circular, and a deep draw die can be made to be circular, therefore a circular pan can be made. For example, a metal spinning process can also be used to make the circular pan. There, the setup expense of the spinning process can be low as compared with the deep draw process, however each has advantages. A square piece can be cut directly from the extruded piece and can be put on a spinning lathe with the flat surface pressed against a die. The piece can be spin cut so that the fin pattern is circular leaving the edge region without any fins or portions of fins. The diameter of the circular fin pattern can be the same as that of the die it is pressed against. The spin press tool can be used to spin the edge region up to form the wall. The top edge of the pot is then spin trimmed. The whole process can be done on a spinning lathe. Therefore the manufacturing process can be of potential low cost.

To complete the piece of cookware, handles can be attached to the wall of the cookware, for example, by welding. The placement of the handles on the wall is away from the channel exits. This placement reduces the chance of the handle being heated up by the hot flame flowing up due to buoyancy along the wall of the piece of cookware, as most of the flame will be guided toward the exits of the channels away from the handle.

For cookware of small sizes, it may be economical to fabricate in volume using casting, as casting tends to have a high upfront tooling cost. The material for the casting can be, for example, aluminum cast alloys that have good thermal conductivity. For example, investment casts, or permanent mold casts can use, for example, alloy 356 which has thermal conductivity of 167 W/mK, while the typical die cast alloy 380 is only 110 W/mK. Additionally, alloy 443 and other exotic aluminum matrix composites (MMX) with good thermal conductivities can be used for die cast as well. One advantage of the casting is that the pot is created as a single a unit rather than requiring welding as described above. Further, the designing of the heat exchange channel can have much more flexibility, for example, the flame entrance opening can be built in. Other patterns such as blunt post pattern can be used in the casting process.

As depicted in FIG. 11, a pot formed as a single piece of cookware is shown. The cast sauce pot 1100 has heat channels fins 1102, and handles 1103 formed at the same time. Therefore, no extra handle attachment is needed. In the die cast process for this particular design, the gating of the die cast mold can be in the center port of the channel fins. The entrance shape of the gating, where the liquid aluminum is injected into the mold during casting, can be a line shape that is transverse relative to the center of the channels. This gating placement can fill the fins from the center position of the channel fins, therefore it can be easier to have fins fill fully as compared with gating at in other locations. There will be a solid piece of aluminum in the gating area that can be machined off to form the flame entrance as shown in FIG. 6 and FIG. 7.

Another good thing about the casting is that the pattern of the fins can have more variations, such as blunt posts 1110 in the middle area to allow flow to come the channels at the same time have some improvement of the heat transfer in that region, as shown in the FIG. 11. Again with flexibility of the casting, more patterns can be incorporated such as louver, curve and other suggested in U.S. patent application Ser. No. 11/992,972.

A die cast process can produce a piece of cookware having a low wall and guide fins while experiencing less difficulty than other processes. For example a sauté pan can be made having a large diameter without handles using the die cast process. Such a sauté pan can have the heat exchange channels defined on the base of the sauté pan. Attaching handles to this base will complete the sauté pan. Alternatively such a sauté pan can be used as a base for a stock pot formed by welding a wall to the sauté pan. Since the sauté pan has a small wall, welding a piece of metal to the small wall can be done with, for example, friction stir welding. Such a process can produce a stock pot having a high quality weld with an aesthetically pleasing appearance. In this way, one die cast mold can be used to produce two types of cookware.

After the body of a piece cookware is made, it can be preferable to apply a hard anodized layer to the inside of the cookware. The hard anodized layer can be chemically inert to resist corrosion, and physically hard to withstand scratches. Cookware typically lasts longer than cookware without a hard anodized layer. However the thermal conductivity of the Aluminum Oxide is only 25 W/mK, much lower than the 210 W/mK of Aluminum. The inside layer should be thick enough, larger than 25 μm, to have wear resistance and corrosion resistance, yet not to impact on the heat conductivity too much. If desired, the outside surface, can be roughened by wire brushing, sand blasting, or other mechanical means. Surface texture can be also formed on the surface of the extruded channel base. For example, fine grooves can be added on the wall of the fins and base from extrusion by detailed design of extrusion die. It should be noted that from a thermal conductivity point of view, anodizing can impair thermal conductivity of aluminum. However it can also be beneficial to have an IR absorbing dark layer on the outside surface of a piece of cookware to improve the radiation thermal heat transfer. A thin anodized layer with IR absorbing dye can be added to improve radiation absorption and at the same time to provide some degree of protection from scratching and erosion.

Alternatively, a layer of stainless steel can be spray coated on the inside surface of the piece of cookware. Stainless steel has poor thermal conductivity thus, the thickness of the stainless steel layer can be optimized for wear and corrosion resistance and to minimize any impact on the thermal conductivity of the piece of cookware.

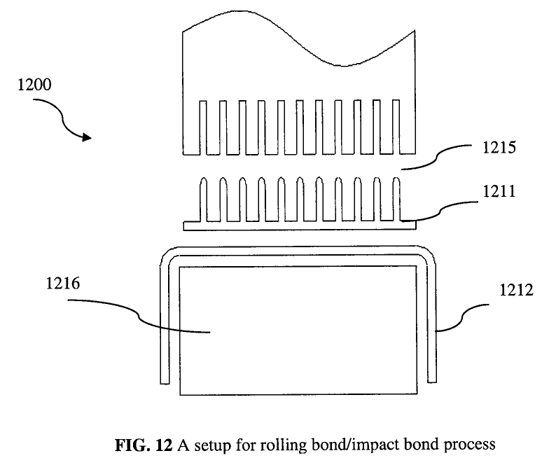

Stainless steel cookware is widely used due to its robustness against corrosion, wear and tear. However stainless steel has a poor thermal conduction coefficient. Also, it is difficult to extrude stainless steel to make channels. One way to achieve efficient heat exchange channels using stainless steel is to attach an aluminum plate with heat exchange channels to the base of a piece of stainless steel cookware. In this process, an extruded plate having proper heat exchange channels on one side of the surfaces is obtained by extrusion. The extruded plate can then be cut into the shape of the base of the stainless cookware. The bonding surface, i.e. the plain face of the extruded plate can be wheel ground, or abraded to remove the surface oxide layer. The base of the stainless cookware is also roughened and cleaned. Bonding can be performed by a rolling press. A rolling press bonding process is depicted in FIG. 12. Where an extruded plate 1211 is heated up to 400° C., a piece of stainless cookware 1212 can be heated to 550 C. An aluminum heat sink can then placed on the base of the stainless cookware. A steel roller 1215 can roll and press the aluminum plate 1211 against the stainless steel cookware 1212 which is placed on the stage 1216 so that the aluminum plate 1211 can be bonded to the stainless steel cookware 1211. The roller 1215 can be specially shaped, i.e. having a ridge pattern complimentary to the channel profile of the extruded aluminum plate. The roller press can exert force via the ridges through the gaps between the fins onto the base of the heat sink when rolling over the whole plate. The linear pattern of the heat exchange channels makes this roller press process possible. Alternatively the heat sink can be pressed onto the bottom of the stainless steel cookware by high pressure impact bond.

The process can also be represented by FIG. 12. The press die 1215 is used to press down on whole base at a same time instead of rolling. The die can have linear ridges to provide a pattern complementary to the channel structure on the extruded aluminum channel plate. A twisting action can be added during the impact to improve the bonding. Other bonding methods such as blazing can also be used.

It will be appreciated to those skilled in the art that the preceding examples and are exemplary and not limiting. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

What is claimed is:

1. A system for transferring heat for cooking food comprising:
a. a base including a cooking side for heating food, and a heating side for receiving heat, the heating side including a linear pattern of flame guiding channels defined by heating fins extending vertically below the heating side, the heating fins operable to receive heat into the guide channels;
b. wherein, in operation, flame is applied to the guide channels via a flame entrance in the heating fins, the hot flame flows within the guide channels distributing the heat over the fins, the fins absorb the heat, and the fins transfer the heat as thermal energy to the cooking side for heating the food.

2. The system of claim 1, wherein said flame entrance opening is circular.

3. The system of claim 1, wherein said flame entrance opening is elongated in the direction perpendicular to said channel direction.

4. The system of claim 1, wherein said flame entrance opening is elliptical with its short axis in the direction of said channels.

5. The system of claim 1, wherein said flame entrance opening is rectangular with shorter side of said rectangle in direction of said channels.

6. The system of claim 1, wherein the height of said fins in said flame entrance opening is designed for uniform flame heating.

7. A system for cooking food using pressure comprising:
a. a cooking chamber having a base and a leak tight lid;
b. wherein, the base includes a cooking side internal to the chamber, and a heating side, the heating side having a linear pattern of flame guiding channels defined by heating fins extending vertically below the heating side, the heating fins operable to receive flames into the guide channels and absorb the heat for transfer to the cooking side in heating food.

8. A system for generating a flame pattern for delivery to a piece of cookware without stagnant airflow comprising:
a. a coupling attachable to a range port for receiving gaseous fuel; and
b. an elongated housing including a pattern of ports extending laterally, operable to direct the gaseous fuel;
c. wherein, in operation, gaseous fuel is received at the coupling and is ignited and dispersed through the ports as a flame, the flame directed via a non-radial symmetric pattern of ports to eliminate stagnant flame flow spot to improve convection heat transfer to a piece of cookware.

9. The system of claim 8, wherein the pattern of ports runs along a line matched to the base of a piece of cookware.

10. The system for generating a flame pattern of claim 8, wherein the pattern of the fuel ports is one row.

11. The system for generating a flame pattern of claim 8, wherein the pattern of the fuel ports is an elliptical shape.

12. The system for generating a flame pattern of claim 8, wherein the coupling is mounted to the range top in such a way so that the coupling can be rotated easily about a vertical axis.

13. The system for generating a flame pattern of claim 8, wherein the pattern of the fuel ports is matched to a flame entrance opening of a piece of cookware.

14. The system for generating a flame pattern of claim 8, further comprise a fuel delivery and control system.

15. A method of making an energy efficient piece of cookware comprising:
a. providing an extruded plate having a pattern of fins defining exchange channels;
b. machining said extruded plate so that said pattern is within an area a distance from the edge of said plate;
c. folding the edge area of the plate towards a plain side of the extruded plate so as to form a wall of a vessel by using a metal forming processes.

16. The method of claim 14, wherein said metal forming process is metal spinning.

17. The method of claim 14, wherein said metal forming process is a deep drawing process.

18. The method of claim 14, wherein said metal forming process is a stamping process.

19. A system comprising:
a. a plate having a cooking surface and a heating surface, the heating surface having a pattern of heat exchange channels defined by a plurality of fins extending below the heating surface to collect energy into heat exchange channels and transfer thermal energy to the cooking surface via the fins;
b. wherein the pattern of heat exchange channels includes a flame entrance to allow flames into the channels between the fins.

20. The system of claim 18, wherein the plate is a griddle plate.

21. The system of claim 18, wherein the plate becomes the bottom of a piece of cookware by bonding the metal plate to the wall of the piece of cookware.

22. The system of claim 18, wherein the plate is bonded to a bottom of a piece of cookware to improve the efficiency of transfer of thermal energy of the cookware.

23. The system of claim 18, wherein the plate is a die cast piece serving as a as a cooking surface of a piece of cookware; wherein the plate can be further attached to a wall of a piece of cookware to become the bottom of the piece of cookware.

24. A method of increasing the surface area of cookware exposed to a heating element comprising:
a. creating a piece of cookware having a base for heating food having two sides, a cooking side and a heating side
b. wherein one or more portions of the heating side of the base of the piece of cookware are extended below the heating surface as fins for defining channels to collect heat so that in use the one or more extended portions of the base are vertically disposed within heat supplied by a heating element located below the base.
